(19) United States
(12) Patent Application Publication
(10) Pub. No.: US 2003/0090598 A1
(43) Pub. Date: May 15, 2003

(54) Method and apparatus for displaying digital images on an article worn by a user

(76) Inventors: Jeanne Muller Johngren, Princeton, NJ (US); Michael Johngren, Princeton, NJ (US)

Correspondence Address: Diane Dunn McKay, Mathews, Collins, Shepherd & McKay, P.A., 100 Thanet Circle, Suite 306, Princeton, NJ, 08540, US

(21) Appl. No.: 10/293,178

(22) Filed: Nov. 12, 2002

Related U.S. Application Data
(60) Provisional application No. 60/338,211, filed on Nov. 13, 2001.

(51) Int. Cl. H04N 9/12; H04N 5/64

(52) U.S. Cl. 348/838; 348/739

(57) ABSTRACT

The present invention relates to a method and apparatus for displaying digital images on an article worn by a user to allow for clothing of all types to display digital information. A screen that can display computer-generated animations can attach to clothing. The screen can be thin, lightweight, and flexible for integration with the article of clothing. The screen can display clear, sharp static and moving images. The visual content displayed on the clothing can be changed by a user by using a wired interface to a computer or by receiving the content via a short- or long-range wireless transmission.

### BACKGROUND OF THE INVENTION

1. Field of the Invention

This invention relates generally to portable electronic and computing devices that interface with an outboard computer and display content and imagery on an attached display (screen) and, more specifically, to “intelligent” clothing and such devices that are worn by the user, as well as any device involved in the visual display of electronic content, including advertising.

2. Description of the Related Art

As portable and hand-held technological devices become more integral in people's lives, apparel and accessory designers are adding features to accommodate the new requirements. There are special pockets in shirts and bags for mobile phones, laptop carrying cases that look like purses and belt clips for CD players. This trend is evolving into a new industry, “smart clothes” or “wearable electronics.” These products involve the sophisticated practice of integrating technology and apparel, thereby increasing the utility of the clothing. Instead of having a pocket in a jacket for a phone, “smart clothes” have speakers built into the hood or a microphone integrated into the collar. “Wearable electronics” is a fledgling industry. Currently, smart clothing is focused on improving utility in the following areas: Health sector for clothes that can monitor vital statistics; information and communications sector for incorporating common electronic devices into clothing; and industrial sector for improving efficiency and communications on the job.

It is desirable to project an individualized message, design, or moving animation on an article of clothing, while retaining the ability to change the displayed imagery to new designs at any time for enabling content to be controlled and changed remotely during use.

### SUMMARY OF THE INVENTION

The present invention relates to a method and apparatus for displaying digital images on an article worn by a user to allow for clothing of all types to display digital information. A screen that can display computer-generated animations can attach to clothing. The screen can be thin, lightweight, and flexible for integration with the article of clothing. The screen can display clear, sharp static and moving images. The visual content displayed on the clothing can be changed by a user by using a wired interface to a computer or by receiving the content via a short- or long-range wireless transmission.

Components of the system include: a wearable article having a display attached to the article, means for generating an image and means for displaying the image. Particular components can include a microcomputer, power source, onboard battery, software for driving the display, wired and/or wireless computer hardware interface, personal computer-based software for loading images into an on-board computer, and Internet-based tools for selecting and creating images to download and play on the display.

In typical operation, a user establishes a connection to a remote programming device through a connection method. Using software installed on the remote programming device, the user can select an image content file to be displayed on the article. The image content file can be loaded into read/write memory of the microcomputer. The computer can be disconnected from the wearable article and the article would be ready to display the selected image. The user would then put on the article and activate the system to display the selected image on the screen attached to the article.

In addition, the present invention provides a method of creating or changing images, delivering program med image content to users and sharing images among users. Users can establish a connection between a remote programming device, such as a personal computer, and the microcomputer through which connection they can transfer image content to display on an article to be worn by a user. The user can then terminate the connection with the remote programming device and display the content on the display while wearing the display.

Alternatively, the article can automatically receive broadcast image content sent to it via a short- or long-range wireless connection. In this mode, an image could be transmitted to the article from a remote programming device while the article is being worn and operated by the user. For example, this embodiment is useful for displaying advertising messages on garments worn by athletes or fans at a sporting event.

The invention will be more fully described by reference to the following drawings.

### BRIEF DESCRIPTION OF THE DRAWINGS

FIG. 1 is a global perspective view of an apparatus for displaying images on an article worn by a user in accordance with the teachings of the present invention.

FIG. 2 is a schematic diagram of components of the apparatus.

FIG. 3 is a flow diagram of steps for playing the displayed designs and communicating with applications.

FIG. 4 is a flow diagram for loading display content into the apparatus.

FIG. 5 is a flow diagram of a website tool for creating and downloading display content.

FIG. 6A is an image of the apparatus attached to an article of clothing.

FIG. 6B is an image of the apparatus attached to an article of clothing.

### DETAILED DESCRIPTION OF THE PREFERRED EMBODIMENT

During the course of this description, like numbers will be used to identify like elements according to the different figures which illustrate the invention.

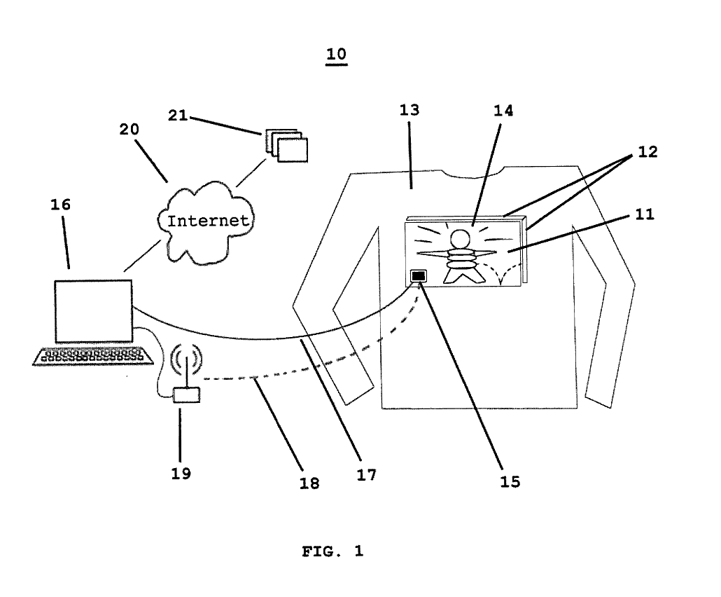

FIG. 1 illustrates apparatus for displaying digital images on an article worn by a user 10, in accordance with the teachings of the present invention. Apparatus 10 includes display 11 attached with attachment 12 to article 13, thereby display 11 becomes a layer of article 13. Attachment 12 can be a hook and loop or other standard snap attachment and can be detached from article 13 to allow for washing.

Display 11 can be formed of a material which is flexible enough to roll and bend without being damaged for integrating display 1 1 on article 13. For example, display 11 can be formed of a polymer organic light-emitting diode (Poly-OLED) including a polymer (plastic) base material which provides the display ability to flex and bend. Suitable Poly-OLED displays are manufactured by DuPont Displays as “Plastic Poly-OLED Display Module”, Phillips and Universal Display Corporation.

Article 13 can be worn by a user. In different implementations, display 11 can be in the form of a screen which can cover the entire article 13 or be attached only to a portion of article 13 which is the desired viewing area. Display 11 can display digital image 14. Digital image 14 has image content which can be text, moving text, static graphical images, or moving images or any combination thereof. Digital image 14 can be an advertising message. Display 11 displays digital image 14 in color or black and white.

Circuit board 15 is coupled to display 11. Wired connection 17 can be used to connect remote programming device 16 to circuit board 14. Alternatively, wireless connection 18 can be used to connect remote programming device 16 to circuit board 15. Circuit board 15 can be a conventional circuit board with wired connections. Alternatively, circuit board 15 can be a “flex circuit” which is integral to display 11. Transceiver 19 can be used to communicate between remote programming device 16 and circuit board 15 using wireless connection 18.

Remote programming device 16 can connect to Internet 20. For example, remote programming device 16 can be a personal computer. Internet software modules 21 are available on Internet 20, as described in detail below.

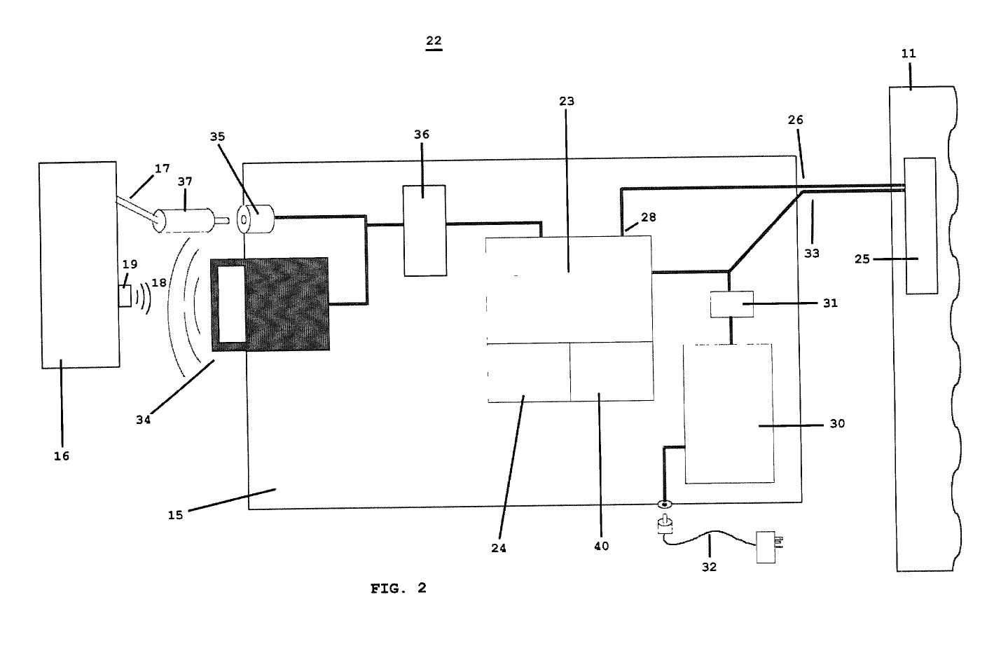

Core system 22 comprises a plurality of components attached or coupled to circuit board 15, as shown in FIG. 2. Core system 22 includes microcomputer 23 with read/write memory 24. Microcomputer 23 is connected to display driver 25 of display 11 by flexible conduit 26. Microcomputer 23 runs software 40 for communicating with remote programming device 16 and interacting with display driver 25 for displaying image content on display 11, as described in detail below. Software 40 is resident in microcomputer 23. Video signal output 28 is routed from microcomputer 23 to display driver 25 via flexible conduit 26.

Battery 30 is resident on circuit board 14. Battery 30 can be light weight. For example, battery 30 can be a small lithium battery that can be recharged and provides adequate power to microcomputer 23 and display 11. Switch 31 is coupled to battery 30. Switch 31 is used to turn display 11 on or off. Outboard power adapter 32 connects to circuit board 15 for recharging from a conventional power receptacle. Power from battery 30 supplies system components such as microcomputer 23, communications interface assembly 36, wireless transceiver 34, and display 11 via conduit 33.

Core system 22 includes a means for communicating with remote programming device 16 by way of wireless transceiver 34 or interface port 35. Communications interface assembly 36 is connected to the microcomputer 23 and also to wireless transceiver 34 or interface port 35. Communications interface assembly 36 allows communication via interface port 35 through wired connection 17, or via wireless transceiver 34 through wireless connection 18 to remote programming device 16 which runs the image-loading software. Both the wired and wireless communications options are shown, but any particular embodiment of the present invention may only include one of these options, or it may include both.

In one embodiment, wireless connection 18 can be achieved using a standard wireless networking protocol such as, but not limited to, Bluetooth, Infrared, or 802.11b (known as “WiFi”). Other wireless protocols can be used to provide communication. Wireless transceiver 34 communicates with transceiver 19 connected to remote programming device 16. Alternately, or in concert with this connection method, wired connection 17 can be provided via interface port 35 that can accept cable 37 with a standard interface plug on the other end for connecting to available ports on remote programming device 16 which can be a personal computer. Wired connection 17 can include, but is not limited to, a Universal Serial Bus, IEEE 1394 (known as “Firewire”), and a standard 9-pin Serial Port.

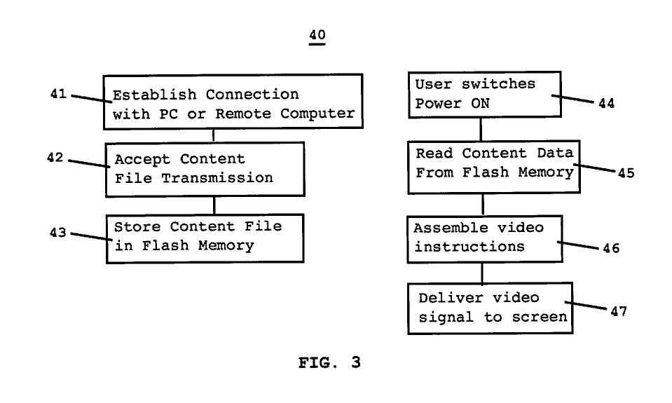

Software 40 to achieve communication with remote programming device 16 is executed by microcomputer 23. FIG. 3 illustrates modules of software 40. When remote programming device 16 attempts to open a connection with core system 22, software 40 runs module 41 to establish a connection through wired connection 17 or wireless connection 18 with remote programming device 16. Remote programming device 16 then transmits an image content file to core system 22 and software 40 accepts the file in module 42. Software 40 stores the content data of the image content file in module 43 in read/write memory portion 24 of microcomputer 23. It should be appreciated that the communications software 40 will utilize appropriate error-checking techniques to ensure reliable data transfer.

Software 40 also performs functions related to displaying the image content of the image display 11. When a user switches on power switch 29 in module 44, module 45 reads the files of content data from read/write memory 24. Module 46 assembles video instructions. Module 47 delivers video signal output 28 to drivers 25 for enabling display of the image on display 11.

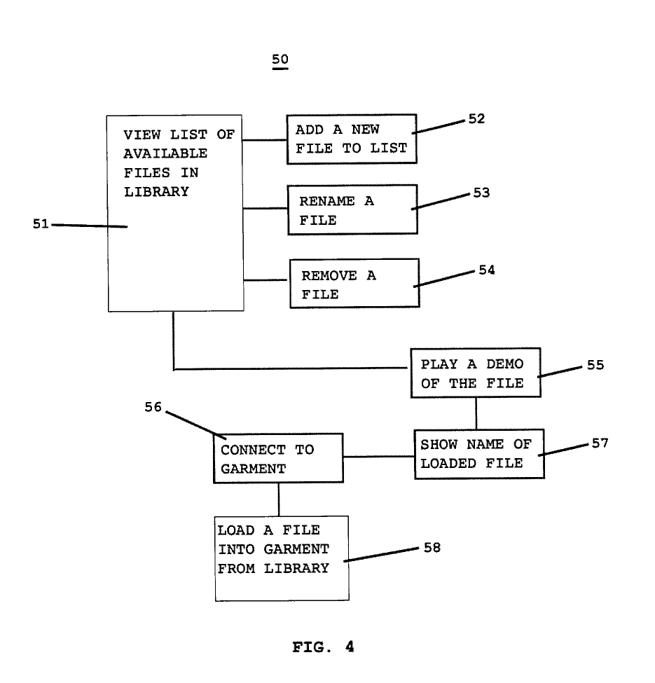

Software 50 can reside in remote programming device 16. Software 50 can be used for organizing, selecting and loading image content to be displayed on the article to be worn by the user. FIG. 4 illustrates modules of operations that software 50 performs. In module 51, a user can view a list of available images that are stored in remote programming device 16. In module 52, a user can add a new file to the list. In module 53, a user can rename a file in the list. In module 54, a user can remove a file from the list. In module 55, a user can select a file from the list and play a demonstration of the file on a screen of remote programming device 16, enabling them to preview the design before loading it into microcomputer 23. In module 56, a user can connect to core system 22. Once a connection with core system 22 is established over wired connection 17 or wireless connection 18, module 57 can show one or more names of one or more corresponding image files currently loaded and stored in read/write memory 24 of microcomputer 23. In module 58, a user can select an image file from the list of available images and load the image into read/write memory 24 by transferring the image over wired connection 17 or wireless connection 18 that has been established.

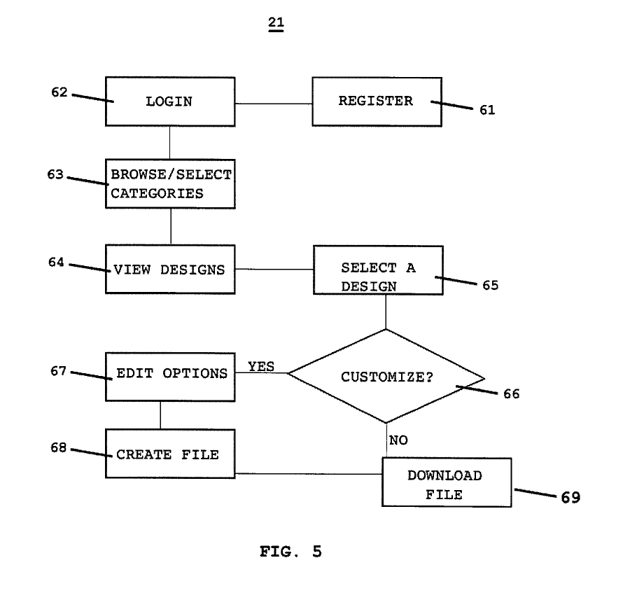

Users can locate, customize, create, and download image files using Internet software modules 21 made available on Internet 20. Internet software modules 21 can provide web-based applications including cataloging of image files that users can choose from, downloading of one or more image files to remote programming device 16, and loading of images into article 13. Internet software modules 21 include module 61 in which a user can register for a service to create an online account at a website, as shown in FIG. 5. Once their account is created, in module 62 a user can login to the website. In module 63, a user can browse or select from a list of image or design categories. In module 64, a user can view samples of image content. Once the user has identified a design that they want to use, a user can select the chosen image in module 65. In module 66, a user can indicate whether they want to customize the design or not. When the options are selected, module 68 creates a file. If the user desires to customize the image, module 67 can be used to edit the available options for the image file such as speed, number of objects displayed, the text of a message to be displayed, and the like. In module 69, a user can transfer the selected image from module 65 or customized image from module 68 to remote programming device 16.

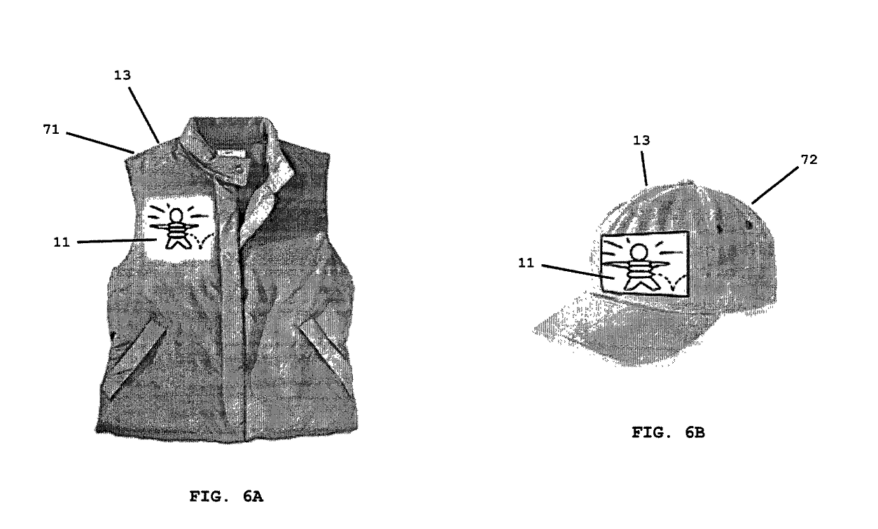

Illustrated in FIGS. 6A-6B are representations of articles 13 including display 11. In this embodiment, the content is animated and, therefore, moves through a sequence in a similar manner to a computer “screen saver” animation. Vest 71 is shown in FIG. 6A. Cap 72 is shown in FIG. 6B. It will be appreciated that the invention can be adapted to any type of clothing or wearable item.

In general, the present invention can be used in advertising, entertainment, sport promotion, leisure and self-expression and other contexts.

It is to be understood that the above described embodiments are illustrative of only a few of the many possible specific embodiments which can represent applications of the principles of the invention. Numerous and varied other arrangements can be readily devised in accordance with these principles by those skilled in the art without departing from the spirit and scope of the invention.

We claim:

1. Apparatus for displaying a digital image on an article worn by a user comprising:
a display attached to said article;
means for generating said digital image; and
means for displaying said digital image on said display.

2. The apparatus of claim 1 wherein said means for generating said digital image is remote from said display.

3. The apparatus of claim 2 wherein said means for generating said digital image comprises a remote programming device, and a connection between said remote programming device and said means for displaying said digital image on said display, said remote programming device generates said digital image and said digital image is transferred over said connection to said means for displaying said digital image on said display.

4. The apparatus of claim 3 wherein said connection is a wired connection.

5. The apparatus of claim 3 wherein said connection is a wireless connection.

6. The apparatus of claim 3 wherein said means for generating said digital image further comprises an Internet connection to said remote programming device and one or more Internet software modules accessed over said Internet connection, each of said Internet software modules performing one or more operations selected from registering for a service to create an online account at a website, browsing a list of a plurality of said digital images, browsing a list of categories of said digital images, viewing samples of said image content, selecting said digital image, editing objects of said digital image and downloading said digital image to said remote programming device.

7. The apparatus of claim 3 wherein said means for generating said digital image further comprises one or more remote programming device software modules performing one or more operations selected from establishing a connection to said means for displaying said image on said display, organizing one or more of said digital images in said remote programming device, selecting said digital image stored in said remote programming device, and transferring said digital image to said means for displaying said digital image on said display.

8. The apparatus of claim 1 wherein said means for displaying said digital image comprises;
a microcomputer connected to said display, a read/write memory associated with said microcomputer for storing said digital image, and one or more microcomputer software modules for retrieving said digital image from said read/write memory and displaying said retrieved digital image on said display.

9. The apparatus of claim 8 wherein said microcomputer and read/write memory are attached to a circuit board.

10. The apparatus of claim 9 further comprising a power supply attached to said circuit board, said power supply powering said microcomputer and said display.

11. The apparatus of claim 10 wherein said power supply is a rechargeable battery.

12. The apparatus of claim 9 wherein said means for generating said image comprises a remote programming device, and a wired connection between said remote programming device and said means for displaying said digital image on said display, said remote programming device generates said digital image and said image is transferred over said wired connection to said means for displaying said digital image on said display and said wired connection comprises an interface port attached to said circuit board and a cable is connected between said remote programming device and said interface port.

13. The apparatus of claim 9 wherein said means for generating said image comprises a remote programming device, and a wireless connection between said remote programming device and said means for displaying said digital image on said display, said remote programming device generates said digital image and said image is transferred over said wireless connection to said means for displaying said digital image on said display and said wireless connection comprises a transceiver attached to said circuit board and a transceiver attached to said remote programming device.

14. The apparatus of claim 13 wherein said digital image is broadcast to said wireless connection.

15. The apparatus of claim 9 wherein said circuit board is integral with said display.

16. The apparatus of claim 1 wherein said display is formed of a flexible material.

17. The apparatus of claim 1 wherein said display is attached to said article with a hook and loop material or a snap fastener.

18. The apparatus of claim 1 wherein said digital image is one or more of text, moving text, static graphical image, moving image or any combination thereof.

19. The apparatus of claim 1 wherein said digital image is in color or black and white.

20. The apparatus of claim 1 wherein said digital image is an advertising message.

21. A method for displaying a digital image on an article worn by a user comprising the steps of:
attaching a display to said article;
generating said digital image; and
displaying said digital image on said display.

22. The method of claim 21 wherein said digital image is generated remote from said display.

23. The method of claim 21 wherein said generating step comprises generating said digital image at a remote programming device, establishing a connection between said remote programming device and means for displaying said digital image on said display attached to said display, transferring said digital image over said connection to said means for displaying said digital image on said display and removing said connection.

24. The method of claim 23 wherein said generating said digital image step further comprises organizing one or more of said digital images in said remote programming device.

25. The method of claim 23 wherein said generating said digital image step further comprises storing said digital image in said remote programming device and selecting said digital image stored in said remote programming device.

26. The method of claim 21 wherein said generating said digital image step comprises the step of establishing an Internet connection between a remote programming device and one or more Internet software modules accessed over said Internet connection.

27. The method of claim 26 wherein said generating said digital image step further comprises the step of registering for a service to create an online account at a website.

28. The method of claim 26 wherein said generating said digital image step further comprises the step of browsing a list of a plurality of said digital images.

29. The method of claim 26 wherein said generating said digital image step further comprises the step of browsing a list of categories of said digital images.

30. The method of claim 26 wherein said generating said digital image step further comprises the step of viewing samples of said image content.

31. The method of claim 26 wherein said generating said digital image step further comprises the step of selecting said digital image.

32. The method of claim 26 wherein said generating said digital image step further comprises the step of editing objects of said digital image.

33. The method of claim 26 wherein said generating said digital image step further comprises the step of downloading said digital image to said remote programming device.

34. The method of claim 21 wherein said displaying step comprises storing said digital image in read/write memory coupled to a microcomputer coupled to said display and retrieving said stored digital image and displaying said stored image in said display.

35. The method of claim 21 wherein said generated digital image is broadcast to said display.

36. The method of claim 35 wherein said digital image is an advertising message.

37. The method of claim 21 wherein said display is formed of a flexible material.

38. The method of claim 21 wherein said display is attached to said article with a hook and loop material or a snap fastener.

39. The method of claim 21 wherein said digital image is one or more of text, moving text, static graphical image, moving image or any combination thereof.

40. The method of claim 21 wherein said digital image is in color or black and white.

41. The method of claim 21 wherein said digital image is an advertising message.

42. Apparatus for displaying a digital image on an article worn by a user comprising:
a display attached to said article;
a microcomputer connected to said display;
a read/write memory associated with said microcomputer for storing said digital image;
a remote programming device and a connection between said remote programming device and said microcomputer, said remote programming device generates said digital image and said image is transferred over said connection to said microcomputer; and
one or more microcomputer software modules for retrieving said image from said read/write memory and displaying said retrieved image on said display.

43. The apparatus of claim 42 wherein said connection is a wired connection.

44. The apparatus of claim 42 wherein said connection is a wireless connection.

45. The apparatus of claim 42 further comprising an Internet connection to said remote programming device and one or more Internet software modules accessed over said Internet connection, each of said Internet software modules performing one or more operations selected from registering for a service to create an online account at a website, browsing a list of a plurality of said digital images, browsing a list of categories of said digital images, viewing samples of said image content, selecting said digital image, editing objects of said digital image and downloading said digital image to said remote programming device.

46. The apparatus of claim 42 further comprising one or more remote programming device software modules performing one or more operations selected from establishing a connection to said means for displaying said image on said display, organizing one or more of said digital images in said remote programming device, selecting said digital image stored in said remote programming device, and transferring said digital image to said means for displaying said digital image on said display.

47. The apparatus of claim 42 wherein said microcomputer and read/write memory are attached to a circuit board.

48. The apparatus of claim 47 further comprising a power supply attached to said circuit board, said power supply powering said microcomputer and said display.

49. The apparatus of claim 48 wherein said power supply is a rechargeable battery.

50. The apparatus of claim 47 wherein said connection is a wired connection which comprises an interface port attached to said circuit board and a cable is connected between said remote programming device and said interface port.

51. The apparatus of claim 47 wherein said connection is a wireless connection which comprises a transceiver attached to said circuit board and a transceiver attached to said remote programming device.

52. The apparatus of claim 51 wherein said digital image is broadcast to said wireless connection.

53. The apparatus of claim 42 wherein said circuit board is integral with said display.

54. The apparatus of claim 42 wherein said display is formed of a flexible material.

55. The apparatus of claim 42 wherein said display is attached to said article with a hook and loop material or a snap fastener.

56. The apparatus of claim 42 wherein said digital image is one or more of text, moving text, static graphical image, moving image or any combination thereof.

57. The apparatus of claim 42 wherein said digital image is in color or black and white.

58. The apparatus of claim 1 wherein said digital image is in color or black and white.

59. A method for displaying an advertising message on an article worn by a user comprising the steps of:
attaching a display to said article;
generating a digital image of said advertising message; and
displaying said digital image on said display.

60. The method of claim 59 wherein said generated digital image is broadcast to said display.
